(19) United States
(12) Patent Application Publication
(10) Pub. No.: US 2015/0354270 A1
(43) Pub. Date: Dec. 10, 2015

(54) RESISTANCE DROP DOWN CURTAIN SET

(71) Applicant: Hsien-Te HUANG, Taipei City (TW)

(72) Inventor: Hsien-Te HUANG, Taipei City (TW)

(21) Appl. No.: 14/465,021

(22) Filed: Aug. 21, 2014

(30) Foreign Application Priority Data
Jun. 10, 2014 (TW) 103210229

(51) Int. Cl. E06B 9/322

(52) U.S. Cl. CPC E06B 9/322

(57) ABSTRACT

A resistance drop down curtain set is provided. An open/close state of the curtain set is changed by directly, manually operating a bottom edge of the curtain to provide a design for effectively preventing the curtain from sliding downwards. A thread exit position of a winding element is indirectly provided with a set of damping device. The damping device restrains a downward sliding force of a drawstring, and further stables a lower truss rod of the curtain to be positioned at a position of any desired horizontal height.

### BACKGROUND OF THE INVENTION

a) Field of the Invention

The invention relates in general to a resistance drop down curtain set, and more particularly to a curtain set that changes an open/close state thereof by directly, manually operating a bottom edge of the curtain to provide a design for effectively preventing the curtain from sliding downwards.

b) Description of the Prior Art

In a conventional curtain set design with an automatic retractable curtain, a limiter for stopping a reverse action of an elastic member is disposed at an operation axis. By using the limiter that provides a one-directional stopping effect, a feedback force of the elastic member is prevented from directly driving a winding element that pulls up the curtain. Thus, a lower truss rod of the curtain can be stopped at a position of any desired horizontal height.

The above system is generally targeted for a system design of a large-sized retractable curtain set. In a recent small-sized curtain set 1 (as shown in FIG. 1), upper and lower delivery heads of a curtain 100 are within a reachable range of the end of a user hand, and upward retraction and down release operations are achieved by manually operating a bottom hem the curtain 100. As such, an open/close state of the curtain can be changed with a simplified structure. In an upper truss rod 10 of the structure, a feedback device 2 and a winding element 11 are similarly provided. The winding element 11 winds a drawstring 12 and penetrates into the curtain 100 to combine with a lower truss rod 13 at the bottom. A counterweight block 14 is provided in the lower truss rod 13. A mass of the counterweight block 14 counterweights an elastic member 20 of the feedback device 2. Further, an elasticity strain curve of the elastic member 20 is drawn from a torque curve that appears more horizontal. As such, when the elastic member 20 is driven by the winding element 11, the stress of the elastic member 20 at any deformation phase is caused to be substantially the same. Therefore, with an appropriate material selection of the elastic member 20 and the counterweight effect of the counterweight block 14, the limiter 15 may be eliminated.

The feedback device 2 is provided inside the system. The feedback device 2 drives the winding element 11 via a guide 21, and is overall carried by the upper truss rod 10. Further, the feedback device 2 is provided with the constant-pressure elastic member 20. The elastic member 20 and the winding member 11 are in a bi-directional linked relationship. The winding element 11 winds the drawstring 12. The drawstring 12 has a body penetrated through the curtain 100 and has an end combined to the lower truss rod 13 that is internally provided with the counterweight block 14.

To release the curtain 100 downwards, a user pulls down the lower truss rod 13 by a hand operation to also at the same time pull down the drawstring 12 that further rotates the winding element 11. A rotational force of the winding element 11 is posed in reverse on the elastic member 20 in the feedback device 2 to form a preparatory feedback elastic stored energy. Once the hand of the user is released, a feedback force of the elastic member 20 containing the stored energy is immediately formed to prevent the lower truss rod 13 from further sliding downwards. Moreover, the feedback force counteracts the mass of the counterweight block 14 such that the curtain 100 is not winded back.

Through the feedback stored energy of the feedback device 2 and the weight effect of the counterweight block 14, it is intended that the lower truss rod 13 at the bottom hem of the curtain 100 be positioned at any desired height during a retraction/release operation. However, the reaction cannot entirely counteract the mass of the curtain 100 that changes in response to the height. The curtain 100 has an overall mass, especially in a curtain set having multiple horizontal plates or a drop down curtain set, the upper edge of the curtain 100 is combined with the upper truss rod 10. When the curtain set is fully released downwards, a load of the pulling force of the drawstring 12 is the lightest as the weight of the upper curtain plates or the curtain is distributed from top to bottom and thus dispersed. When the lower truss rod 13 is gradually pulled upwards, curtain plates are sequentially accumulated at the top part of the curtain set to sequentially increase the load due to the weight, such that the load on the pulling force of the drawstring 12 is also increased to even reach a maximum load. Therefore, as the horizontal position of the lower truss rod 13 varies, the load on the drawstring 12 for pulling the curtain 100 at the corresponding height also becomes different. As a result, the constant-pressure elastic member 20 having a fixed pressure value cannot provide a fully balanced effect for preventing the curtain 100 at any height from sliding downwards or winding upwards.

To overcome the above issue, a common method is to select an appropriate material for the feedback force of the elastic member 20. The elastic member 20 is selected in a way that a loading capability for an overall weight of the curtain 100 and the counterweight block 14 is satisfied. Thus, when retracted upwards, the curtain 100 is completely and steadily carried to allow the lower truss rod 13 to be positioned at a highest horizontal position. Further, when released downwards, the lower truss rod 13 is allowed to be positioned at any desired height.

In practice, the feedback force of the feedback device 2 is required to be at least close to counterbalancing a maximum weight when the lower truss rod 13 is winded upwards plus the overall weight of the counterweight block 14, resulting in an extremely large feedback energy load. However, when the curtain 100 is completely released, the pulling load of the drawstring 12 is equal to the feedback energy load, which is the lightest at this point. Further considering a force of an airflow blowing through a window, a momentum of the curtain 100 may be changed. Thus, it is frequent that the curtain 100 of the curtain set 1 becomes winded upwards when being released downwards, or the hem of the curtain 100 that is half drawn drops downwards. One reason causing the above is that, although the elastic member 20 and the counterweight block 14 are designed to counterbalance, external forces containing variables may be posed on the curtain set 1 to exceed a range of the counterbalancing effect.

Further, the counterbalancing design of the elastic member 20 and the counterweight block 14 requires high-performance and high-precision parts as well as precise calibration and replacement procedures during an assembly process. However, as the pressure of the natural airflow traveling through the window is not in a constant value, mechanical waves are generated after the airflow passes by/through the curtain 100. Multiplying the mechanical waves with the gravity mass effect, the lower truss rod 13 often causes the curtain 100 to slide downwards or wind upwards.

### SUMMARY OF THE INVENTION

It is a primary object of the present invention to provide a system capable of preventing a curtain from sliding downwards and keeping an operation load on a lax drawstring when a winding element is retracted as well as minimizing a weight of a feedback device of the system.

To achieve the above object, in one embodiment, an upper truss rod of the system is internally provided with a damping device. The damping device is provided with a damping wheel that can be winded by a body of a passing drawing string. With tread damping or rotary damping of the damping wheel, the curtain is effectively prevented from sliding downwards.

To achieve the above object, in one embodiment, the damping wheel provided at the damping device is in a quantity of two at left and right sides horizontally.

To achieve the above object, in one embodiment, the damping wheel provided at the damping device is in a quantity of two at top and bottom sides vertically.

To achieve the above object, in one embodiment, at least two damping wheels are provided at the damping device. One of the damping wheels has an adjustable angle relative to another damping wheel.

To achieve the above object, in one embodiment, the damping wheels provided at the damping device may be laterally interfered by a brake device. The brake device is tunable to change the damping energy of the damping wheel.

To achieve the above object, in one embodiment, an energy load posed by the winding element on the winding energy of the drawstring is minimal as the winding element purely serves for winding and releasing a lax drawstring. Through an adjustable transmission device, a linkage state providing a transmission and decelerating effect is generated between the winding element and an elastic member of a feedback device to further reduce a deformation of the elastic member.

To achieve the above object, in one embodiment, a displacement mechanism is provided to support the damping wheel for up/down displacements. When the damping wheel is pulled down and impelled by the drawstring, a frictional force is generated by a brake portion to provide a brake force that prevents the drawstring from sliding downwards.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a counterweight device for counterbalancing a feedback device in a conventional curtain set;

FIG. 2 is a schematic diagram of a curtain set provided with a damping device of the present invention;

FIG. 3 is a schematic diagram illustrating an interference effect of a damping device on a drawstring of the present invention;

FIG. 4 is a schematic diagram illustrating a lax state between an upper end of a drawstring and a damping device of the present invention;

FIG. 5 is a schematic diagram of horizontal corresponding damping wheels of the present invention;

FIG. 6 is a schematic diagram of vertical corresponding damping wheels of the present invention;

FIG. 7 is a schematic diagram of two damping wheels of the present invention, with one of the damping wheels having an adjustable relative horizontal angle;

FIG. 8 is a side view of a braking device providing a damping effect of the present invention;

FIG. 9 is a schematic diagram of a displacement mechanism that assists in braking of the present invention; and

FIG. 10 is a schematic diagram of a displacement mechanism that assists in braking of the present invention.

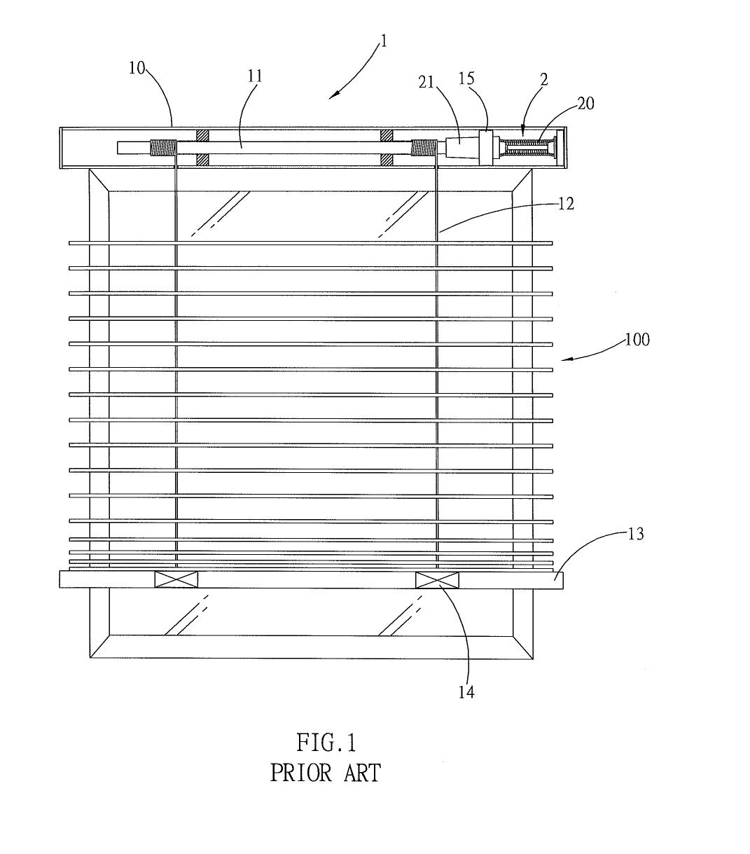

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings.

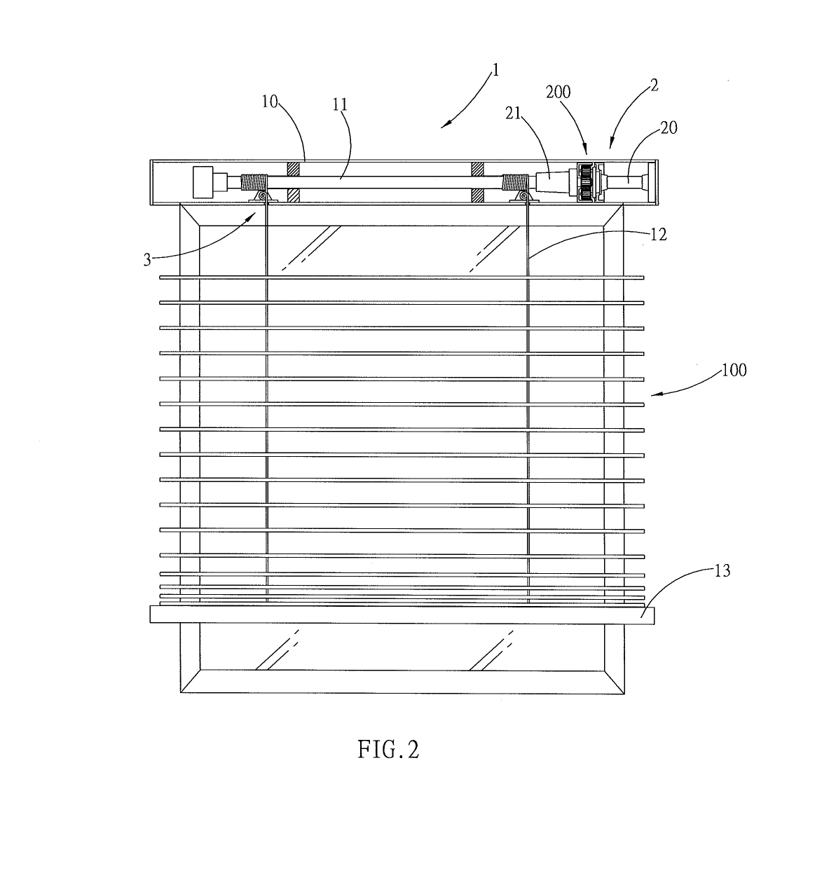

Detailed structures and operation principles of the present invention are described with reference to FIG. 2 below. Referring to FIG. 2, a curtain set 1 of the present invention provides a design that effectively prevents a curtain 100 from sliding downwards. A set of damping device 3 is indirectly provided at a thread exit position of a winding element 11. The damping device 3 limits a down-sliding force and further enables a lower truss rod 13 of the curtain 100 to be positioned at a position of any desired horizontal height.

In the system, an upper truss rod 10 is provided with a feedback device 2. The feedback device 2 includes an elastic member 20, and forms a bi-directional linked relationship with the winding element 11 via a guide 21. The elastic member 20 features a constant-pressure characteristic. An upper end of a drawstring 12 winds around the damping device 3 and becomes winded around an outer surface of the winding element 11. Further, after a body of the drawstring 12 is penetrated through the curtain 100, a lower end of the drawstring 12 is combined to the lower truss rod 13. Due to lightweight operations of the winding element 11, a transmission device 200 in form of a planetary gear set is provided between the winding element 11 and the elastic member 20 to indirectly change a ratio of revolutions of the winding element 11 and the elastic member 20. The transmission device 200 decelerates the elastic member 20, and thus a deformation rate of the elastic member 20 may also be reduced.

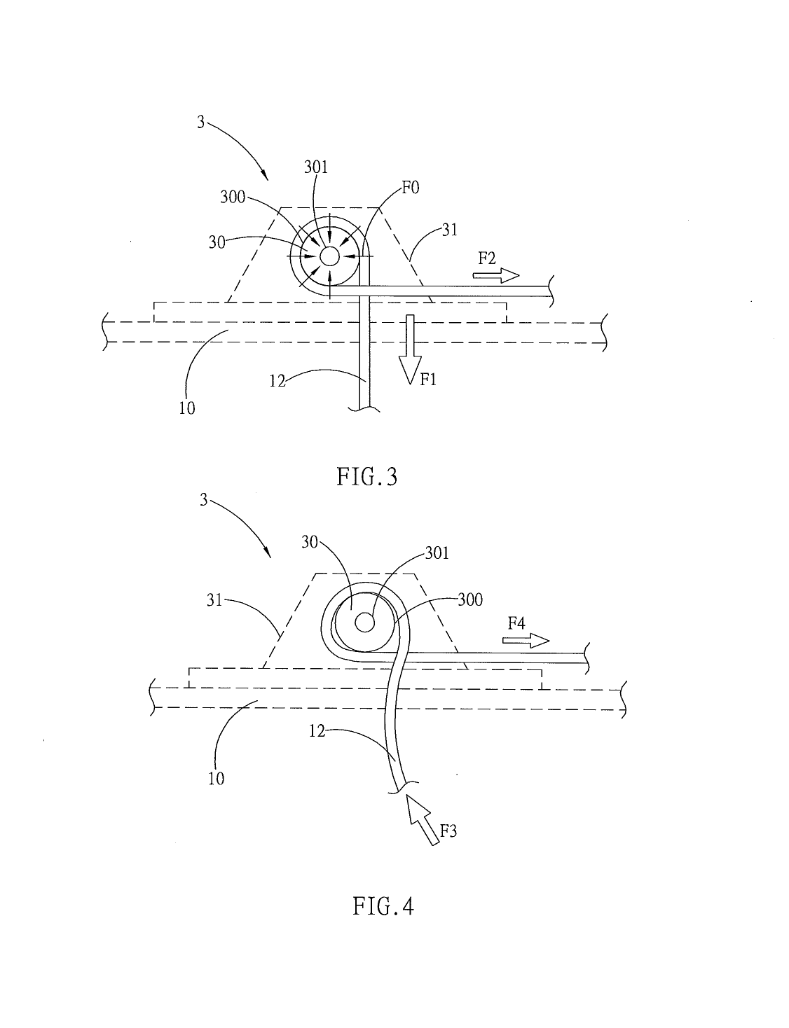

The damping device 3 may be implemented by various methods. In one embodiment, the damping device 3 is implemented by a damping wheel 30 to provide a damping effect. Referring to FIG. 3, to keep the diagram simple, a body section of the drawstring 12 in contact with the damping wheel 30 and winding the damping wheel 30 by 270 degrees is depicted. A downward puling force of the curtain 100 pulls the lower truss rod 13 of the curtain 100 to pull downwards. Such force cannot be counterbalanced by the damping force of the damping wheel 30. With friction and resistance that a tread 300 of the damping wheel 30 forms on the drawstring 12, or an encircling binding force formed by a binding effect at a surface of the damping wheel 30 for rotary damping, the drawstring 12 is prevented from sliding downwards and hence maintains the position of the curtain 100 from sliding downwards.

The damping device 3 is combined to the upper truss rod 10 corresponding to a position of the thread exit position of the winding element 11. According to an outgoing direction of the drawstring 12, a staggered angle of the drawstring 12 and the damping wheel 30 may be adjusted. As shown in the diagram, the incoming direction and the outgoing direction are 90 degrees. The drawstring 12 winds around the tread 300 of the damping wheel 30 of the damping device 3. The damping wheel 30 is combined to a seat 31 via a center axis 301 thereof. The damping wheel 30 and the center axis 301 are positioned at the seat 31 in a fixed manner relative to each other. Alternatively, a rotary damper is provided between the damping wheel 30 and the center axis 301. A force of the damper is greater than an overall weight of the curtain 100 plus a force of the curtain 100 driven by wind.

When put to application, a weight of the curtain 100 or a momentum of an airflow causes the curtain 100 to slide downwards, and such external descending force is insufficient for counteracting the damping force. The drawstring 12 is driven downwards to generate a downward pulling force F1. A binding force F0 is generated by the tread 300 from the drawstring 12 that winds around the damping wheel 30 and binds the curtain 100. The downward pulling force F1 is inadequate for pulling the damping wheel 30. When the damping wheel 30 is not rotated, the downward pulling force F1 cannot pull down the curtain 100. At this point, another holding force F2 for holding the curtain 100 occurs at the other end. Such holding force F2 is caused by a reverse pulling force on the winding element 11 in a tangent point length of the tread 300 of the damping wheel 30 due to the holding force. The holding force F2 that holds the curtain 100 keeps the drawstring 12 to stay in contact with the tread 300, and the binding force that pulls the curtain 100 downwards is generated by the contact surface between the body of the drawstring 12 and the tread 300. To achieve a greater binding force, the drawstring 12 may wind the damping wheel 30 by two rounds for a tighter binding effect. When the damping wheel 30 and the center axis 301 are both positioned at the seat 31 in a fixed manner relative to each other, a frictional force is provided by winding the drawstring 12 around the tread 300 of the damping wheel 30. The frictional force may be converted to a damping force, and is greater than the overall mass of the curtain 100 and smaller than a manual operation force.

To release the curtain 100 downwards, the lower truss rod 13 is manually pulled downwards. The pulling force indirectly propels the damping device 3 via the drawstring 12 to drive the winding element 11. At the position of the damping device 3, as the force of the manual down-pulling force is quite large, due the holding effect of the holding force F2, the downward pulling force F1 generated produces a large binding force F0 that takes effect at the damping wheel 30. Meanwhile, the binding force F0 also overpowers the predetermined damping force of the damping wheel 30 to drive and rotate the damping wheel 30, such that the drawstring 12 is dropped down to release the curtain 100 downwards. Even when the damping wheel 30 is fixed, the power of the manual operation still overpowers the frictional force between the drawstring 12 and the tread 300 to achieve the required operation.

Referring to FIG. 4, to retract the curtain 100, the lower truss rod 13 is manually pushed upwards to generate a lifting force F3. Thus, the foregoing pulling force that the body of the drawstring 12 poses on lower truss rod 13 disappears, and a lax state is produced between the drawstring 12 and the damping wheel 30 of the damping device 3. When the lower truss rod 13 is manually pushed upwards and retracted, due to the interference asserted by the lifting force F3 on the curtain 100, the body of the drawstring 12 immediately loses the contact friction relative to the tread 300 of the damping wheel 30 to become a lax state. The lax state is immediately acted by a winding force F4 that winds the curtain 100. The winding force F4 that winds the curtain 100 is caused by the feedback device 2. At this point, the damping wheel 30 and the center axis 301 are independent from the damping state, and the damping wheel 30 is still and not rotated. The curtain 100 is pushed upwards by the lifting force F3 to disengage the body of the drawstring 12 from the tread 300 of the damping wheel 30 to become a lax state. The free body section in a lax state is winded around the round outer surface of the winding element 11 by the winding force F4 of the feedback device 2 of the system, and so the energy load of the winding operation of the winding element 11 is limited to winding only the lax drawstring 12. Therefore, the feedback device 2 of the system may adopt a lightweight and compact design.

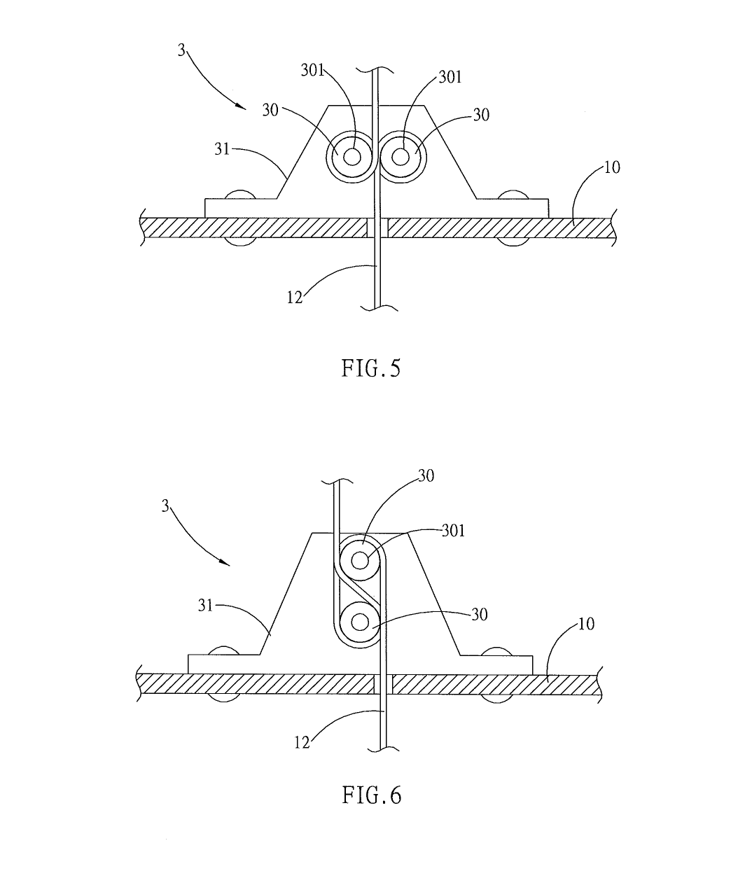

Referring to FIG. 5, in one embodiment of the present invention, the damping device 3 is combined to the upper truss rod 10, and two corresponding damping wheels 30 are provided at the seat 31 of the damping device 3 in a horizontal manner via respective center axes 301. Further, the drawstring 12 may wind around one of the damping wheels 30 and wind in reverse around the other damping wheel 30 to form a bow-shaped route. Thus, the reverse winding forms an even tighter binding force on the two damping wheels 30. One of the damping wheels 30 may be designed as a free wheel, or both of the damping wheels 30 may be designed with a damping effect. Such horizontal design may be implemented for a heavyweight curtain 100.

Referring to FIG. 6, in one embodiment of the present invention, to obtain a larger damping effect in applications of a heavier curtain, two upper and lower damping wheels 30 may be provided at positions along a vertical line of the seat 31 of the damping device 3. The drawstring 12 is winded as an S-shaped route to similarly achieve a greater damping effect. One of the damping wheels 30 may similarly be a free wheel.

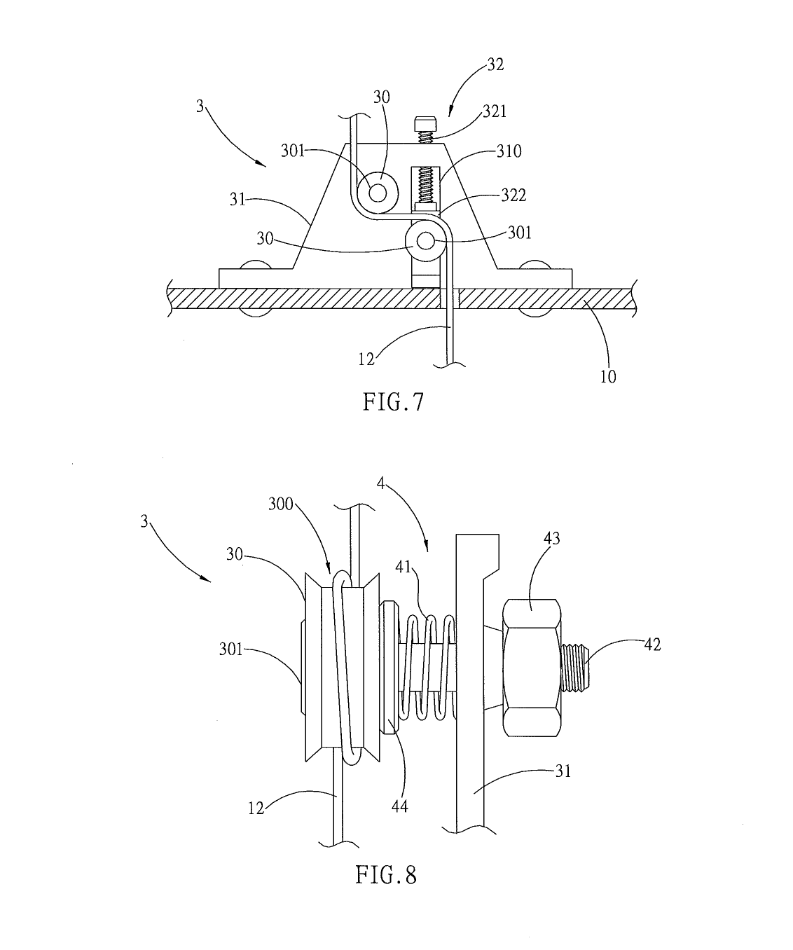

Referring to FIG. 7, in one embodiment of the present invention, the seat 31 of the damping device 3 may be provided with a sliding groove 310. The sliding groove 310 allows a sliding block 322 to slide therein. One of the damping wheels 30 is combined to the seat 31 via the corresponding center axis 301, and the other damping wheel 30 is combined to the sliding block 322 via the corresponding center axis 301. The sliding block 322 receives modulation of a bolt 321 provided in a modulation device 32 to change an up/down displacement status thereof. The up/down displacement status may change a horizontal angle relative to the other damping wheel 30. By changing the horizontal angle, a contact area of the drawstring 12 that winds around the damping wheels 30 may be changed to adjust the winding angle of the drawstring 12 to further achieve different damping effects.

Referring to FIG. 8, in one embodiment of the present invention, a main body of the damping device 3 is supported by the seat 31, and an interactive damping effect may be generated between the center axis 301 of the seat 31 and the damping wheel 30. The center axis 301 may be extended to receive restraints of a brake device 4. The brake device 4 includes an adjustment rod 42, which is extended coaxially with the center axis 301 and is penetrated through the seat 31. A tension spring 41 is provided at opposite sides of the seat 31 and the damping wheel 30. With the tension of the tension spring 41, a frictional force, i.e., the damping force, is generated on the damping wheel 30.

One end of the tension spring 41 is located at a corresponding surface of the seat 31, and the other end of the tension spring 41 acts on the corresponding surface of the damping wheel 30 via a pressing ring 44. By adjusting a depth of the adjustment rod 42 through the modulation member 43, a deformation rate of the tension sprig 41 is changed. Further, unequal elastic strain forces caused in response to the deformation rate take effect on one side of the damping wheel 30 to generate different damping effects, such that the lower end of the drawstring 12 winded around the damping wheel 30 obtains different damping capabilities.

In one embodiment of the present invention, the damping wheel 30 may be displaced up and down from the horizontal position. When the damping wheel 30 is displaced downwards, the tread or the body section of the drawstring 12 winded around the damping wheel 30 is restrained by an external force to provide an assist damping effect.

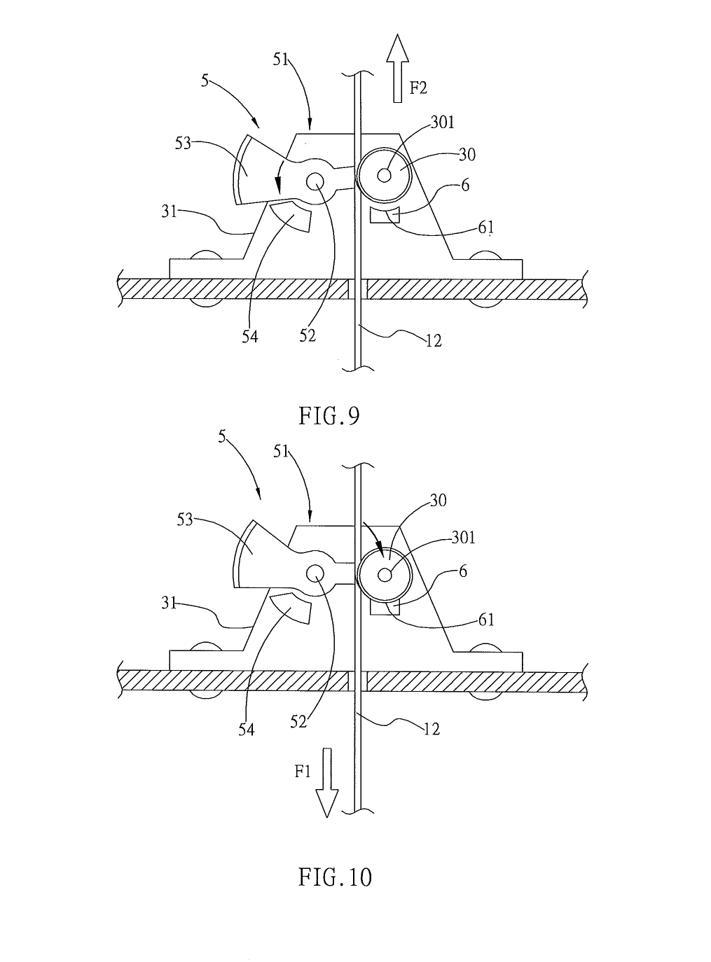

In one embodiment, a displacement mechanism 5 may be used to support the damping wheel 30 for up/down displacements. FIG. 9 shows details of the structure and operations of the displacement mechanism 5. The displacement mechanism 5 is assembled to one side of the seat 31, includes a swing rod 51, and is connected to the seat 31 via a fulcrum 52. The swing rod 51 has one end provided with a counterweight block 53, and the other working end assembled to the damping wheel 30 via the center axis 301. As previously described, the tread of the damping wheel 30 may be winded by the drawstring 12. Via the fulcrum 52, the swing rod 51 forms swinging movements to allow the damping wheel 30 to displace up and down. When the drawstring 12 descends, the damping wheel 30 is propelled to also descend the damping wheel 30. When descended via the center of the fulcrum 52, the tread of the damping wheel 30 is rubbed by a brake surface 61 of a brake portion 6 to form an assist damping effect. The friction of the brake portion 6 on the damping wheel 30 may be directly applied to the corresponding tread of the damping wheel, or may be applied to a surface of the thread of the drawstring 12 winded using the brake portion 6—both of the above forms generate a damping and frictional effect.

A lower end of the counterweight block 53 may be provided with a limit bump 54. The limit bump 54 limits a swing angle of the swing rod 51 from getting excessive, so as to define an up/down displacement angle of the damping wheel 30 within a small range.

Referring to FIG. 10, to release the curtain, a manual operation is applied, i.e., a downward pulling force F1 is applied to the drawstring 12. As the body section of the drawstring 12 is winded around the damping wheel 30, when the damping wheel 30 is descended due to the swinging movements of the damping wheel 30 regarding the fulcrum 52 as a center, a frictional force is generated at the periphery tread of the damping wheel 30 and the surface of the body of the winded drawstring 12 by the brake surface 61 of the brake portion 6. The frictional force acts on the surface of the body of the drawstring 12 winded around the damping wheel 30, or the brake surface 61 directly generates a frictional force on the tread of the damping wheel 30. Both of the above forms generate a damping effect on the damping wheel 30.

When the damping wheel 30 and the center axis 301 are fixed relative to each other, a frictional force may be generated on the drawstring 12 winded by the brake surface 61. When the damping wheel 30 and the center axis 301 are mobile relative to each other, given the damping wheel 30 is rotatable, the brake surface 61 may directly generate a frictional force on the tread of the damping wheel 30.

To retract the curtain, the drawstring 12 may become lax according to the operation in FIG. 4. Thus, the counterweight block 53 falls and a swing angle is limited by the limit bump 54, such that a lax state is formed between the drawstring 12 and the damping wheel 30 to facilitate the winding process.

With the support of the above displacement mechanism 5, the damping wheel 30 is allowed to displace up and down. During the up/down displacements, the damping wheel 30 or the outer surface of the center axis 301 that is winded is restrained by the brake portion 6 to generate a damping effect. The brake surface 61 of the brake portion 6 may be designed as a serrated surface or a rough surface having a frictional effect, thereby generating a frictional force on the damping wheel 30 or the surface of the body of the drawstring 12 winded to achieve a substantial damping effect.

The damping wheels 30 in the above devices are disposed via the corresponding center axes 301. The damping wheel 30 may be designed to be fixed or rotatable, and has a tread 300 with a radial direction parallel to the incoming/outgoing direction of the drawstring 12. To coordinate with the incoming/outgoing direction, the axial direction of the center axis 301 of the damping wheel 30 is perpendicular to the incoming/outgoing direction of the drawstring 12, thereby allowing the drawstring 12 to enter and exit the tread 300 of the damping wheel 30 along a tangential direction.

With the structure set forth by the above description, a design capable of preventing the curtain 100 from sliding is provided. The damping device 3 is disposed at a thread exit position of the winding element 11. The damping device 3 provides a damping effect on the downward sliding movements of the drawstring 12. The energy of the damping effect is based on a fundamental principle of being greater than empirical values of a mechanical oscillation force generated by wind blowing on the curtain 100, and the damping effect of the damping device 3 is smaller than a manual pulling force. Further, when the drawstring 12 retracts the curtain 100 upward by a manual operation, the lower truss rod 13 ascends to eliminate the pulling force from the drawstring 12, in a way that the body section of the drawstring 12 at the damping wheel 30 is in a lax state and is disengaged from the damping device 3. The elastic member 20 at the other side forms a lightweight rotary load that winds the lax drawstring 12. In summary, according to the concept of the system, the damping device 3 that one-directionally interferes the drawstring 12 is provided at the thread exit end of the winding element 11.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A resistance drop down curtain set, entirely manually operated to change an open-close state of a curtain, comprising a design that prevents the curtain from sliding downwards, the resistance drop down curtain set including
an upper truss rod, provided with a winding element in an internal vertical space;
a feedback device, having a working end being in linked relationship with the winding element;
a set of drawstring, having an upper end winded and combined to the winding element, a body penetrated through a curtain, and a lower end combined to a lower truss rod; and
a set of damping device, provided in the upper truss rod, comprising a seat, located at a thread exit position of the winding element, the seat combined with a damping wheel, a tread of the damping wheel being winded by the passing body of the drawstring;
wherein, the damping wheel one-directionally limits the drawstring from being released downwards, and has a damping force smaller than a force of the manual operation.

2. The resistance drop down curtain set according to claim 1, wherein an axial direction of a center axis of the damping wheel is perpendicular to a direction of a thread exit route of the winding element.

3. The resistance drop down curtain set according to claim 1, wherein the damping wheel is in a quantity of two, the two damping wheels are assembled to one side of the seat in a corresponding left-right arrangement, and the two center axes are parallel.

4. The resistance drop down curtain set according to claim 1, wherein the damping wheel is in a quantity of two, the two damping wheels are assembled to one side of the seat in a corresponding top-bottom arrangement, and the two center axes are parallel.

5. The resistance drop down curtain set according to claim 4, wherein the damping wheel is in a quantity of two respectively disposed at two sides of the seat, the two center axes are parallel, the center axis of one of the damping wheels is combined to a sliding block, and the sliding block is modulated by a bolt to perform up/down modulation displacements on a sliding groove of the seat.

6. The resistance drop down curtain set according to claim 1, wherein the damping wheel generates a damping effect as receiving an effect of a brake device; the brake device is a tension spring having one end restrained by the seat and one other end pressed against a corresponding surface of the damping wheel.

7. The resistance drop down curtain set according to claim 6, wherein the tension spring has one end pressed against a corresponding end surface of the damping wheel via a press ring and one end butted against the seat, the center axis of the damping wheel is pivotally penetrated through the damping wheel and has one other end coaxially combined with the an adjustment rod, and the adjustment rod modulates a length of the tension spring by an adjustment device to change a damping coefficient.

8. The resistance drop down curtain set according to claim 1, wherein between the winding element and the feedback device is indirectly provided with a transmission device.

9. The resistance drop down curtain set according to claim 8, wherein the transmission device is a planetary gear set.

10. The resistance drop down curtain set according to claim 8, wherein the transmission device reduces an operation rotational speed of the feedback device.

11. The resistance drop down curtain set according to claim 1, wherein the damping wheel is supported by a displacement mechanism for up-down displacements, and is braked by a brake device when descended.

12. The resistance drop down curtain set according to claim 11, wherein the displacement mechanism is a swing rod connected to the seat, the swing rod has a working end combined to the damping wheel, and a brake portion is provided facing a lower side of the damping wheel.

13. The resistance drop down curtain set according to claim 12, wherein the swing rod has one end opposite the damping wheel provided with a counterweight block.
